(19) United States
(12) Patent Application Publication
(10) Pub. No.: US 2010/0066730 A1
(43) Pub. Date: Mar. 18, 2010

(54) System for illustrating true three dimensional images in an enclosed medium

(76) Inventor: Robert Grossman, Santa Maria, CA (US)

Correspondence Address: SILVERSKY GROUP LLC, 5422 LONGLEY LANE, SUITE B, RENO, NV, 89511, US

(21) Appl. No.: 11/810,485

(22) Filed: Jun. 5, 2007

(51) Int. Cl. G06T 15/00

(52) U.S. Cl. 345/419

(57) ABSTRACT

A system for generating three-dimensional images within an enclosed volume wherein the images are oriented with X, Y, and a Z axes. The system includes a transparent housing capable of allowing a collimated light to pass therethrough, at least one laser for producing at least one beam of collimated light, a plurality of light activated units capable of emitting light at threshold θ when activated by the collimated light generated by the laser apparatus. In addition, the system also includes a suspension medium for suspending light-activated units. The suspension medium is a compound with a density capable of suspending the light activated units in a uniform fashion throughout the space

### FIELD OF THE INVENTION

The present invention relates with a system and apparatus for forming three-dimensional images in an enclosed medium or space.

### BACKGROUND OF THE INVENTION

To date, many attempts have been made to illustrate various images with three-dimensional effects. To create the illusion of three dimensions on a flat, planar surface such as a piece of paper or a television, various techniques such as shading, contrasting backgrounds and foregrounds, and polarizing light are used. Many of these techniques have been around for decades, others for millennia. However, only one technique has been proven to be able to truly depict images in three dimensions, to wit, sculpture.

Although the art of sculpture is at least a couple millennia old, it has hitherto not been replaced by the latest technology. Whereas many techniques, arts, and technologies endeavor to simulate three-dimensional images, they are all limited to projections upon a single flat surface.

One of the primary limitations which inheres in the art of sculpture for depicting three-dimensional images is the requisite intensive human labor for each work. The art of sculpting a work requires extraordinary physical exertion, manual dexterity, artistic talent, and abundant supplies of energy. And today, over 500 years after Michelangelo, the art of sculpting still requires an extraordinary amount of human labor, skill, dexterity, and time.

Nowhere is this limitation in sculpture seen more readily than in the process of designing the automobiles of the future. Today, the world's leading automobile manufacturers are still consigned to the rigors of sculpting accurately scaled replicas of future automobiles. The limitations of illustrating three-dimensional images on a computer monitor or flat screen television are so great that each proposed design must be sculpted using many of the same skills, human exertion, and techniques used in the days of Michelangelo. Needless to say, this immense expenditure of man hours, exertion, money, and time has drastically impeded the process of innovation. Due to the costs and time for sculpting these replicas, fewer innovations and ideas are pursued and explored resulting in stifled innovation.

In addition, these scaled replicas are not capable of illustrating dynamic motion. Since these scaled replicas are forever fixed in time and dimension, they are incapable of illustrating various images in motion. Needless to say, this particular quality renders them incapable of illustrating events in real time from real time data inputs. Therefore, these engineers are not able to use these models to depict how they move around corners, how they react to motion, and other attendant issues.

Illustrating various dynamic images in motion in three dimensions would provide a fundamental paradigm shift in many different industries. For instance, medical schools would be enabled to give a truly comprehensive view of the inner workings of a human body without the need of cadavers, photographs, and textbook illustrations which only provide a very truncated and eclipsed view of the various organs which comprise various systems of the human body.

Other industries such as the entertainment industry could also benefit immensely from such technology. Video game designers would be able to leverage these technologies to revolutionize the manner in which games are experienced and displayed. Moreover, in the related industry of skills training such as flight simulation and golf-swing analysis, three-dimensional graphics can be used to greatly expedite various learning curves.

Therefore, what is clearly needed in the art is a system, apparatus, and related methods for depicting various images in three dimensions. This system would be leveraged in a panoply of different industries for the purpose of entertainment, design manufacturing, toys, air traffic control, marketing, tomography, cartography, research, military-related applications, and skills training. This system would represent a fundamental departure from existing means of conveying, expressing, and conceptualizing ideas. Through this paradigm shift of communication and conceptualization, the system would be applicable in manifold endeavors.

### SUMMARY OF THE INVENTION

It is an object of the present invention to generate true three-dimensional images wherein the images are disposed within three planes which may be coordinated with x, y, and z axes. The system is capable of generating static and dynamic images. Said images are capable of being changed or altered through real time inputs.

It is an object of the present invention to provide a paradigm shift in illustration which is applicable in a panoply of industries through a panoply of different applications, tools, and systems. This system is capable of conveying vast amounts of visual information hitherto unseen in three dimentsions.

### BRIEF DESCRIPTION OF THE DRAWING FIGURES

FIG. 1 is a perspective view of a preferred embodiment of the present invention.

FIG. 2 is a perspective view of a preferred embodiment of the present invention.

FIG. 3 is a perspective view of a preferred embodiment of the present invention.

FIG. 4 is a perspective view of a preferred embodiment of the present invention.

FIG. 5 is a perspective view of a preferred embodiment of the present invention.

FIG. 6 is a perspective view of a preferred embodiment of the present invention.

FIG. 7 is a perspective view of a preferred embodiment of the present invention.

FIG. 8 is a perspective view of a preferred embodiment of the present invention.

### DESCRIPTION OF PREFERRED EMBODIMENTS

According to a preferred embodiment of the present invention, a unique system and apparatus are used to generate three-dimensional images which are disposed within three planes: X, Y, and Z. The present invention should not be confused with prior art which illustrate images on a two-dimensional plane using various methods and technologies which create the illusion of a three dimensional object using shading, shadowing, and related techniques. The present invention generates images in a volume. For this reason, a viewer may be able to view an image from the front, top, sides, and the rear. Consequently, the viewer may either physically move himself to another position, or move the present invention to view different angles of the displayed images. The present invention is described in enabling detail below.

For the purposes of the present invention the term “laser” shall mean or refer to a device that produces a nearly parallel, nearly monochromatic, and coherent beam of light by exciting atoms to a higher energy level and causing them to radiate their energy in phase. Moreover, the term “laser” shall further include any of several devices that emit highly amplified and coherent radiation of one or more discrete frequencies. One of the most common lasers makes use of atoms in a metastable energy state that, as they decay to a lower energy level, stimulate others to decay, resulting in a cascade of emitted radiation. In addition, the terms “beam” and “collimated light” are interchangeable for the present invention.

For the purposes of the present invention the term “volume” shall refer to the general space within the housing. “Volume” also describes the concept that each point within this “volume” may have a light activated unit (or LAU) which is able to be fluoresced, upon the activation by the collimated light.

For the purposes of the present invention the term “bucky-ball” shall refer to the Buckminster Fullerene Compound. These are the chemical compounds which are alternatively referred to as “fullerenes” of the carbon allotrope family. Although these buckyballs may embody many different shapes such as spheres, ellipsoids, tubes, etc., for the purposes of the present invention the buckyballs are spherical.

Moreover, buckyballs have been found in a variety of formulations with varying numbers of carbon atoms. For the purposes of the present invention the number of carbon atoms to be used with the present invention is immaterial insofar as the buckyball can either house a light emitting atom or molecule(s) or can attach to the same.

In addition, the term, “buckyball compound” shall refer to the combination of a buckyball along with a light emitting atom, molecule or compound (hereafter LAU). These LAU's possess chemoluminescent properties. Moreover, it is immaterial for the purposes of the present invention whether the buckyball either houses the LAU or merely bonds with the LAU.

Also, for the purposes of the present invention the terms “suspension medium” and “matrix” are interchangeable. Moreover, the terms “LAU's” and “pixel bodies” are also interchangeable for the purposes of the present invention.

It should be noted here that the present invention not only seeks to generate three dimensional images which are static, but also to generate dynamic images illustrating movement of images. For this reason, the present invention should not be construed to only generate static images. Rather, the present invention may also generate movies, video games, flight simulation, and the like. The possibilities are endless.

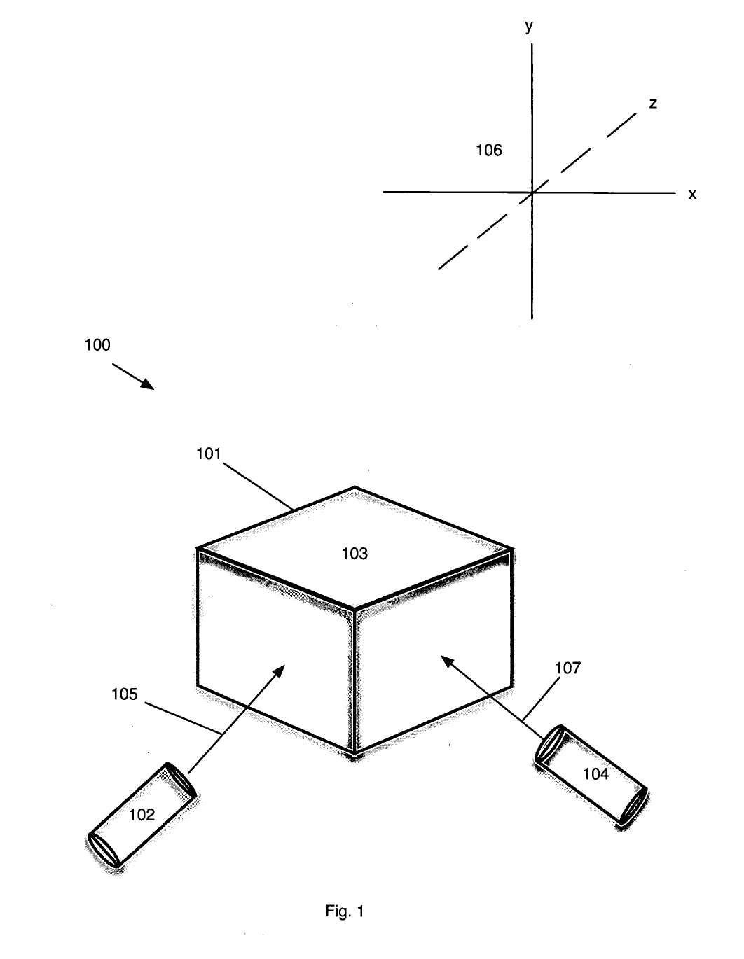

FIG. 1 illustrates a preferred embodiment of the present invention. A system 100 for generating three-dimensional images in an enclosed volume wherein the images are oriented with X, Y, and Z axes. The system includes a transparent housing 101 capable of allowing collimated light from a laser to pass therethrough. The system also includes at least one laser 102 for producing collimated light, a plurality of laser activated units 103 (LAU's) capable of emitting light at threshold θ when activated by the collimated light generated by the laser. Moreover, in some preferred embodiments, the system may optionally include a base for providing stability for the housing. It should be noted here that the base in some preferred embodiments may house and conceal the lasers.

FIG. 1 also illustrates a second laser 104 in those preferred embodiments incorporating more than one laser. It should also be noted that in FIG. 1 the laser activated units are microscopic or sub-microscopic and are thus not capable of illustration at this scale. Moreover, FIG. 1 also illustrates an X, Y, and Z coordinate legend 106 for the purposes of emphasizing the three-dimensional nature of the present invention.

The transparent housing to be used with the present invention may be comprised of plexiglass or quartz in some preferred embodiments. However, other materials may also be used as well such as glass. Furthermore, in some preferred embodiments where the housing is comprised of glass, the glass may be specially treated to absorb various pre-determined ultraviolet wavelengths emitted by the laser.

The shape of the transparent housing may embody a panoply of different shapes and configurations. For instance, various medical imaging applications may incorporate a transparent housing with a rectangular design. In entertainment applications such as video games a cubed or spherical transparent housing may be a preferred configuration. In air traffic control-related applications a cube-shaped housing may prove to be most expedient shape. Moreover, it should be noted that in some preferred embodiments, the transparent housing may be comprised of a material moldable by user in order to adjust to the most expedient shape for a particular application. The possibilities are endless.

The light activated units (LAU's) in some preferred embodiments are either quantum dots or buckyball compounds. LAU's are analogous to pixels in a television screen or related monitor. In some preferred embodiments, these LAU's operate through chemoluminescence. Quantum dots are nanoscale crystals made of a few hundred atoms. They are made from a panoply of various substances and compounds and may be engineered to chemoluminesce in almost any color. Quantum dots are well-known in the art and no further detail will be mentioned hereinafter.

Buckyball compounds, refer to a spherical fullerene compound which either houses an atom or compound which fluoresces or bonds with the same. These buckyball compounds may be introduced into the system through mixing them with various solvents known in the art to be expedient for making fullerene extract mixtures. Examples of these solvents are: 1,2,4-trichlorobenzene (20 mg/ml), carbon disulfide (12 mg/ml), toluene (3.2 mg/ml), benzene (1.8 mg/ml), chloroform (0.5 mg/ml), carbon tetrachloride (0.4 mg/ml), cyclohexane (0.054 mg/ml), n-hexane (0.046 mg/ml), tetrahydrofuran (0.037 mg/ml), acetonitrile (0.02 mg/ml), and methanol (0.0009 mg/ml). It should be noted that the aforementioned solvents are not intended to be construed to be a complete and comprehensive list of preferred solvents to be used with the present invention. Said solvents are enumerated for illustrative purposes only.

In some preferred embodiments each bucky-ball compound contains a light-emitting compound when excited by a plurality of collimated lights which surpass a threshold of energy Ψ. Or, in the alternative, those preferred embodiments which utilize quantum dots may re-emit light when excited by intersecting lasers which surpass the threshold of energy Ψ.

For the purposes of the present invention the laser can be any commercially-available apparatus which produces collimated light. One known example in the art is a Helium-Neon laser. In some preferred embodiments the laser may be rather compact so as to remain somewhat obscure or to be hidden within an aesthetic structural housing.

FIG. 1 illustrates that the laser produces a first collimated light ζ 105 with energy Ω which is lesser than threshold θ of the LAU. The second laser produces a second collimated light 107 which intersects with the first collimated light. And only upon the intersection of two or more collimated lights will the LAU's possess the requisite energy Ω in order to fluoresce and produce light. In other words, an LAU will only be actuated when threshold θ is attained. Threshold θ is only attained when a first collimated light ζ is intersected with at least one more collimated light with a separate energy Θ in order to reach threshold θ.

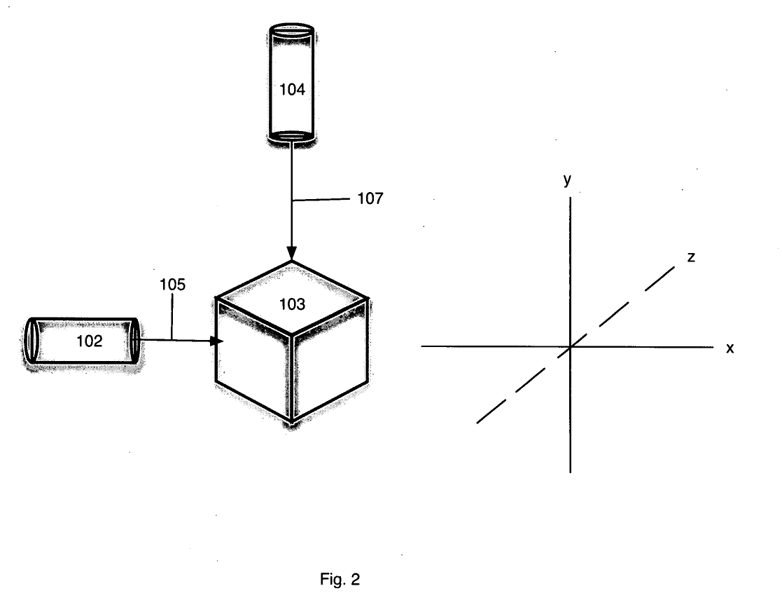

FIG. 2 illustrates a preferred embodiment wherein a first laser is disposed on the X-axis and .a second laser is disposed on a Y-axis. Other embodiments may further include additional lasers on a Z-axis as well. In addition, it may be expedient in some embodiments to mobilize the laser with a robotic arm, motor-powered rollers, or other means suitable for the purpose of moving the collimated light of the lasers to generate the desired images in a dynamic view.

The system also incorporates a suspension medium 108 for suspending LAU's. The suspension medium is a compound with a density capable of suspending the LAU's in a uniform fashion throughout the volume. In some preferred embodiments the medium is an optically-transparent fluid compound capable of allowing collimated light from a laser to pass therethrough. It should be noted that as with the LAU's the suspension medium is incapable of being illustrated due to its optically clear nature. The figure number is used to illustrate that it will be contained in the housing.

The LAU's in some preferred embodiments are either quantum dots or buckyball compounds. It should be noted here that other compounds hitherto unknown or non-existent may be interchangeably used as an LAU. Moreover, other nanotechnology hitherto known or unknown may also prove to be expedient for the purpose of the LAU's. For this reason, the present invention should not be construed to only require the use of buckyball compounds or quantum dots. Other expedient materials may be used interchangeably insofar as they achieve the chemoluminescent properties required of the present invention.

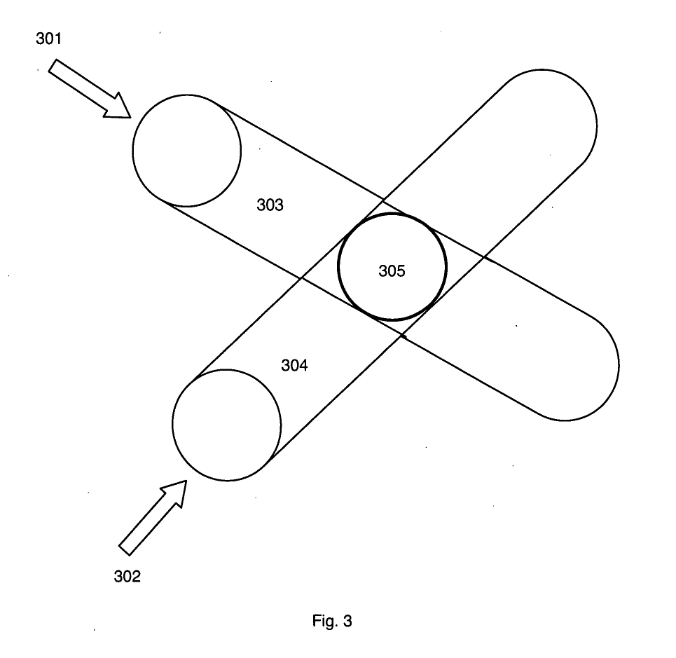

FIG. 3 illustrates how images are formed within the housing. The first collimated light 301 is directed into the housing. The second collimated light 302 is also directed into the housing. Although both lights traverse through a plurality of LAU's through paths 303, 304, they do not luminesce because they lack the requisite energy to activate. However, only at intersection 305 does a spherical image form from the intersection of the collimated lights.

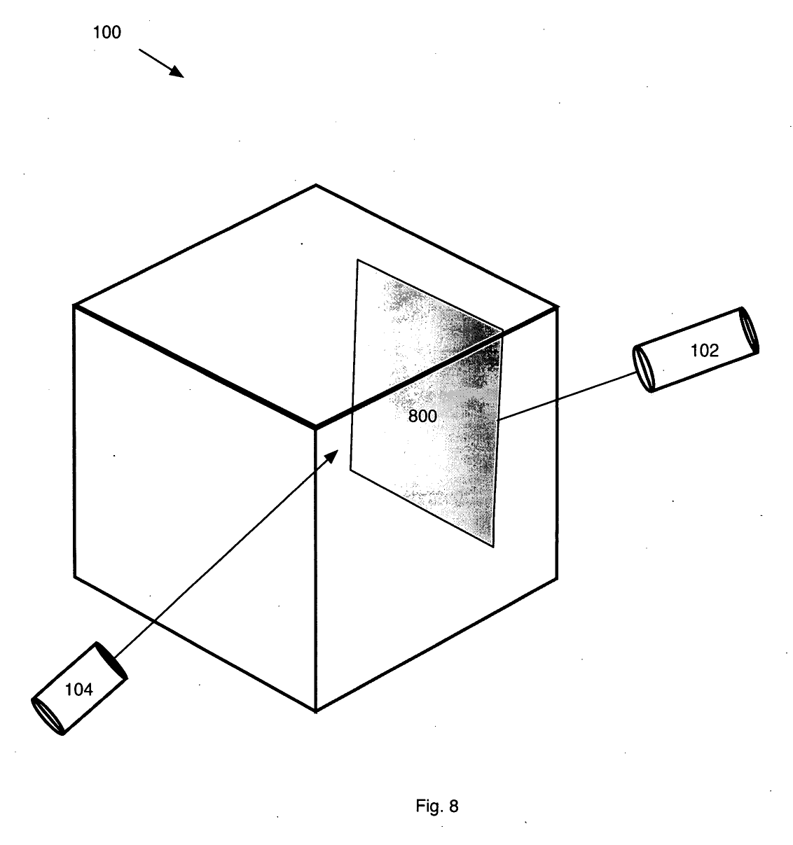

FIG. 8 illustrates one technique for the purpose of forming images with the present invention. One easy technique for making images is to make a planar image 800 with the first laser 102. With the second laser 104, collimated light may be directed towards the planar image in order to form a three dimensional object. By moving the collimated light from the second laser, the process of forming the images is much easier. Other related techniques for forming the images will be readily discerned from those skilled in the art.

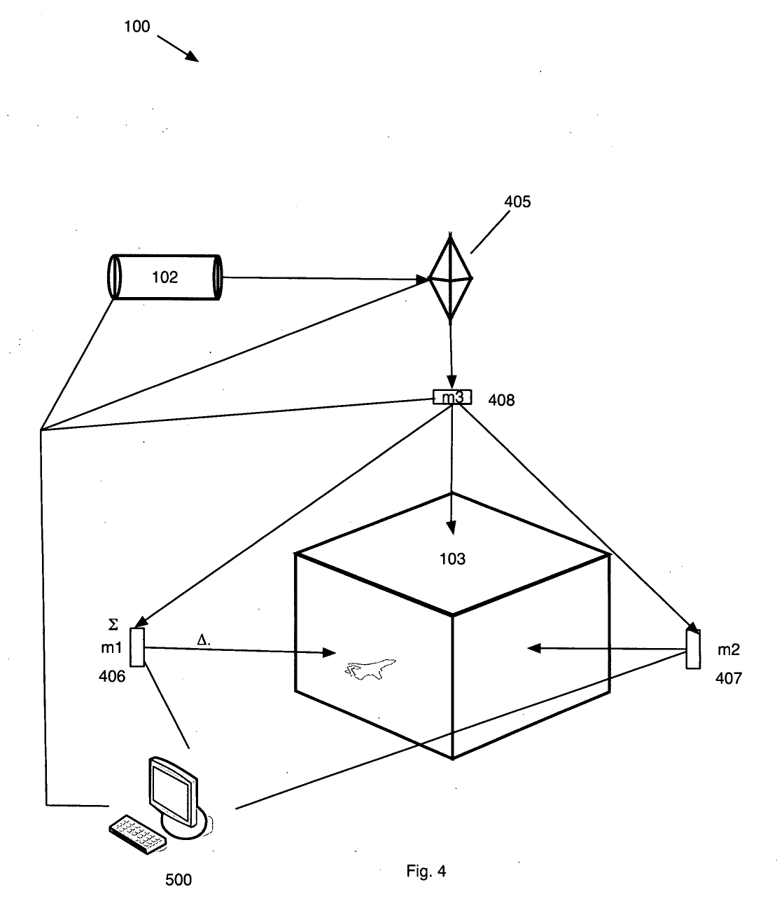

FIG. 4 illustrates a preferred embodiment wherein the system further incorporates a beam splitter 405, a first mirror 406, a second mirror 407, and a third mirror 408. The computer 500 along with accompanying software and peripherals direct the movement of the beam splitter, mirrors, and any articulating motors working in conjunction with the mirrors, beam splitter, and/or laser.

It should be noted that through use of a beam splitter it may be possible to operate the present invention with only one laser. By splitting the collimated light into a plurality of separate beams and through re-direction of the beams with the mirrors it may be possible to generate an infinite number of beams from one single collimated light.

FIG. 4 also illustrates the first mirror disposed at location Σ. The mirror reflects the collimated light into direction Δ. The same process occurs with other mirrors and beam splitters.

It should be noted that mirrors and beam splitters may be affixed to robotic arms, articulating motors, or similar apparatus for the purpose of moving the lasers. This motor or robotic arm would be controlled by a computer system or similar apparatus.

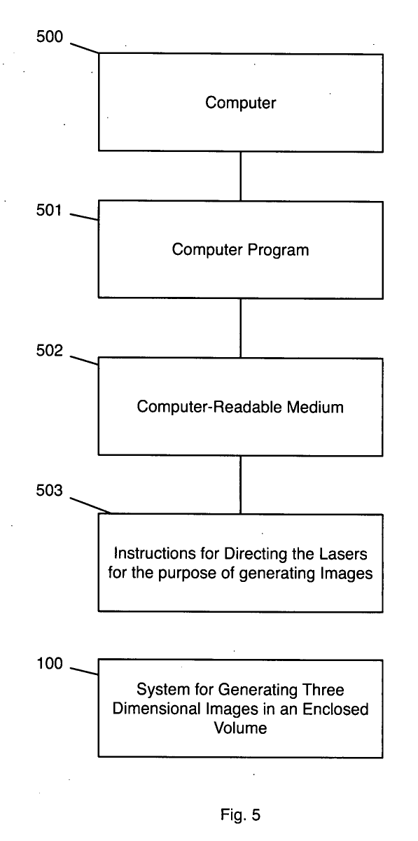

FIG. 5 illustrates a preferred embodiment further comprising a computer system for use in directing the lasers for the purpose of generating intended images. The system 100 may incorporate in some preferred embodiments: a computer 500 and a computer program 501, stored on a computer readable medium 502 and executable by a computer system. The computer program may comprise instructions 503 for directing the lasers for the purpose of generating images.

It should be noted here that not all preferred embodiments require a computer system for use with the present invention. Other preferred embodiments may be enabled with simple manual dexterity. For this reason, the present invention should not be construed to incorporate a computer system and attendant software with all preferred embodiments.

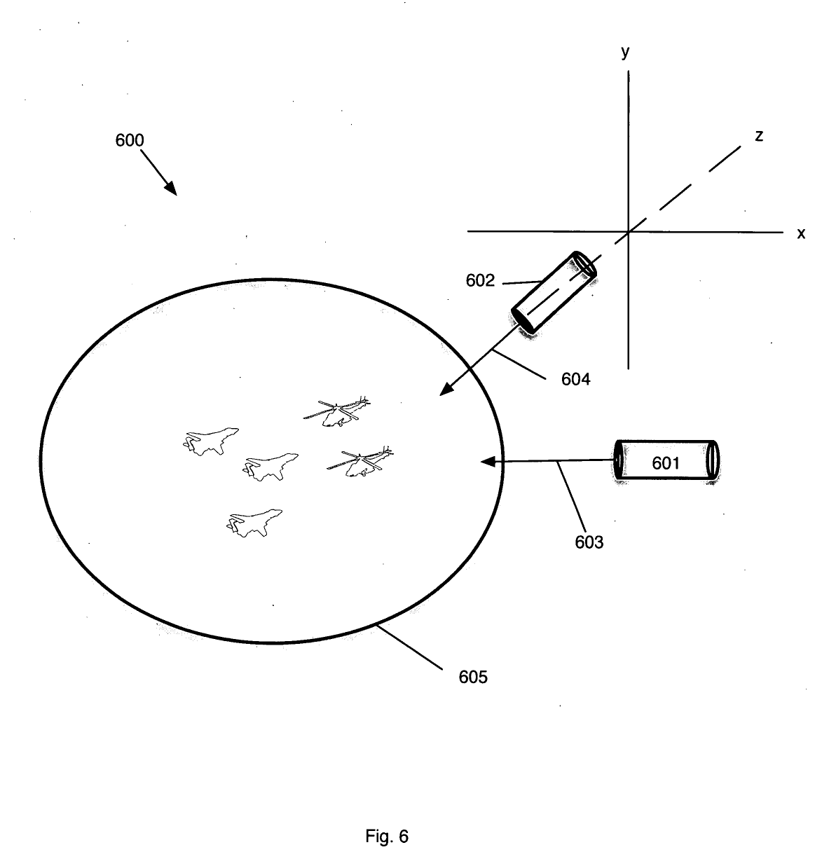

FIG. 6 illustrates a preferred embodiment of the present invention. A military surveillance and reconnaissance system 600 capable of tactical visualization of military components adaptable for use with real time data inputs for generating three dimensional images in an enclosed volume wherein the images are oriented with X, Y, and a Z axes includes a transparent housing 605 capable of allowing a beam 603, 604 to pass into the matrix. The system also incorporates at least one laser apparatus 601, 602 for producing the beams. Moreover, the system also includes a plurality of chemoluminescent units capable of emitting light at threshold θ when activated by the collimated light generated by the laser apparatus. In addition, the system further incorporates a suspension matrix for suspending chemoluminescent units. The suspension matrix is a compound with a density capable of suspending the chemoluminescent units in a uniform fashion throughout the space.

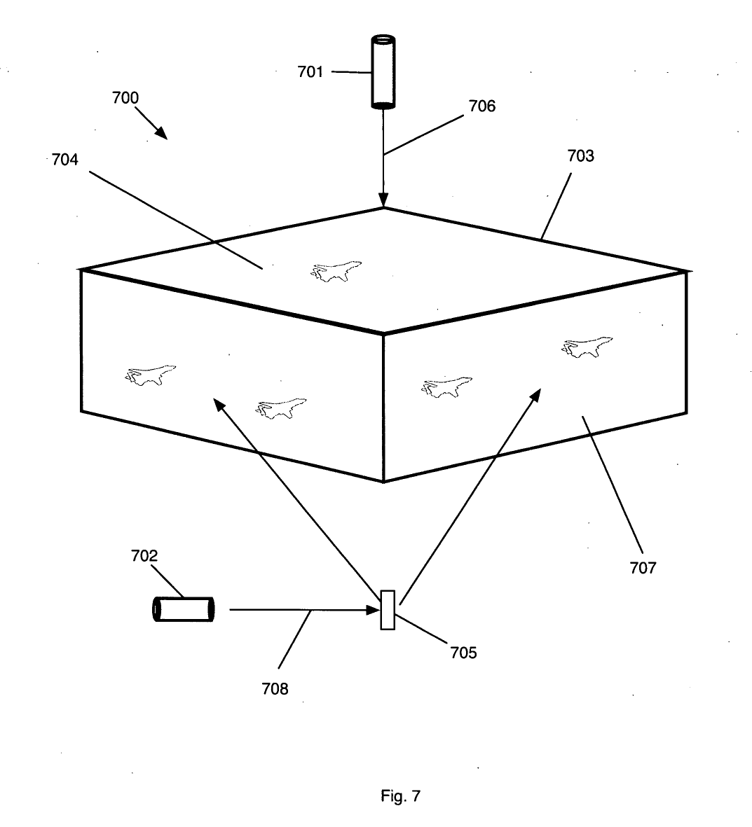

FIG. 7 illustrates a preferred embodiment of an Entertainment System 700 wherein the system is used for generating three dimensional images in an enclosed volume wherein the images are oriented with X, Y, and a Z axes as a flight simulator. The system 700 incorporates a first laser unit 701, a second laser unit 702, a structure 703, a matrix medium 704, pixel bodies 707, a mirror 705, a first light 706, and a second light 708. This preferred embodiment operates in a similar fashion as the previously mentioned embodiments.

The transparent structure is capable of allowing light to pass through its casing. The casing may be comprised of glass, plexiglass, or other suitable material. The plurality of pixel bodies are capable of emitting light at threshold θ when activated by the light generated by the laser units.

The matrix medium is incorporated for use in suspending pixel bodies. The matrix medium is a compound with a density capable of suspending the pixel bodies in a uniform fashion throughout the space.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A system for generating three dimensional images within an enclosed volume wherein the images are oriented with X, Y, and a Z axes comprising:
a transparent housing capable of allowing a collimated light to pass therethrough;
at least one laser for producing at least one beam of collimated light;
a plurality of laser activated units capable of emitting light at threshold θ when activated by the collimated light generated by the laser apparatus;
a suspension medium for suspending laser-activated units; the suspension medium is a compound with a density capable of suspending the laser activated units in a uniform fashion throughout the space.

2. The system of claim 1 wherein the laser produces a first collimated light ζ with an energy Ω which is lesser than the LAU threshold θ.

3. The system of claim 2 wherein the laser activated units are actuated only upon the intersection of 2 or more laser lights.

4. The system of claim 1 wherein any point within the enclosed volume is selectable for illumination upon the intersection of 2 or more laser lights.

5. The system of claim 1 wherein the laser activated unit is a quantum dot.

6. The system of claim 1 wherein the laser activated unit is a bucky-ball compound.

7. The system of claim 1 wherein the transparent housing is quartz.

8. The system of claim 1 wherein the transparent housing is plexiglass.

9. The system of claim 3 wherein each bucky-ball compound contains a light-emitting compound when excited by a threshold of energy Ψ.

10. The system of claim 1, further comprising a computer and a computer program, stored on a computer readable medium and executable by a computer system, the computer program comprising instructions for directing the lasers for the purpose of generating images.

11. The system of claim 2 wherein the first laser apparatus is disposed on an X-axis.

12. The system of claim 2 wherein the second laser apparatus is disposed on a Y-axis.

13. The system of claim 1 wherein the suspension medium is an optically-transparent fluid compound capable of allowing collimated light from a laser to pass therethrough.

14. The system of claim 1 further comprising a computer for the purpose of directing the first and second laser apparatus.

15. The system of claim 1 further comprising at least one mirror disposed at location Σ; the mirror reflects the collimated light into direction Δ.

16. The system of claim 1 further comprising a beam splitter for splitting collimated light into a plurality of collimated lights.

17. A military surveillance and reconnaissance system capable of tactical visualization of military components adaptable for use with real time data inputs for generating three dimensional images in an enclosed volume wherein the images are oriented with X, Y, and a Z axes comprising:
a transparent housing capable of allowing a beam to pass therethrough;
at least one laser apparatus for producing a beam;
a plurality of chemoluminescent units capable of emitting light at threshold θ when activated by the beam generated by the laser apparatus;
a suspension matrix for suspending chemoluminescent units; the suspension matrix is a compound with a density capable of suspending the chemoluminescent units in a uniform fashion throughout the space.

18. An entertainment system for generating three dimensional images in an enclosed volume wherein the images are oriented with X, Y, and a Z axes comprising:
a transparent structure capable of allowing light to pass therethrough;
a first laser unit for producing light; a second laser unit,
a plurality of pixel bodies capable of emitting light at threshold θ when activated by the light generated by the laser apparatus;
a matrix medium for suspending pixel bodies; the matrix medium is a compound with a density capable of suspending the pixel bodies in a uniform fashion throughout the space.

18. (canceled)

19. (canceled)

20. The system of claim 1 wherein any point within the enclosed volume is selectable for illumination upon the intersection of 2 or more laser lights.
